(19) United States
(12) Patent Application Publication
(10) Pub. No.: US 2024/0310131 A1
(43) Pub. Date: Sep. 19, 2024

(54) HEAT EXCHANGER AND MANUFACTURING METHOD THEREFOR

(71) Applicant: ZHEJIANG ASCENRISE HEAT PUMP CO., LTD., Jinhua, Zhejiang (CN)

(72) Inventor: Kaijian WANG, Jinhua (CN)

(21) Appl. No.: 18/575,732

(22) PCT Filed: Jun. 30, 2022
(86) PCT No.: PCT/CN2022/102968

§ 371 Date: Dec. 29, 2023

(30) Foreign Application Priority Data
Jun. 30, 2021 (CN) 202110738485.4
Sep. 30, 2021 (CN) 202111159483.6

(51) Int. Cl. F28F 3/08; B21D 53/04; B23P 15/26; F28D 9/00

(52) U.S. Cl. CPC F28F 3/08; B21D 53/04; B23P 15/26; F28D 9/00

(57) ABSTRACT

A heat exchanger and a manufacturing method therefor. The heat exchanger includes multiple microstructure sheets, each of the microstructure sheets including a heat exchange region with a microstructure and an edge region with an inlet region and an outlet region, and the microstructure comprising multiple hollow protrusions; and multiple gaskets for microstructure sheets, each of the gaskets for microstructure sheets having an inlet port and an outlet port respectively corresponding to the inlet region and the outlet region, and the multiple gaskets for microstructure sheets being alternately stacked with the multiple edge regions. Compared with a traditional etching process, the heat exchanger has expanded options for a forming process, and the process is simple, low in production cost, high in production efficiency, and low in environmental pollution.

### TECHNICAL FIELD

The present invention relates to the technical field of heat exchange devices, and in particular, to a heat exchanger and a manufacturing method therefor.

### BACKGROUND

Heat exchangers transfer part of heat of hot working fluids to cold working fluids, and are also referred to as heat transfer devices.

Microchannel sheet heat exchangers are novel heat exchangers, which are formed by alternately stacking working fluid channel sheets with refrigerant fluid channels and working fluid channel sheets with working fluid channels.

However, the refrigerant fluid channels and the working fluid channels are formed through physical or chemical etching, which causes high material consumption, high manufacturing costs, low production efficiency, and certain environmental pollution.

In view of this, it is necessary to provide an improved heat exchanger and a manufacturing method therefor.

### SUMMARY

The present invention aims to provide a heat exchanger and a manufacturing method therefor.

In order to solve one of the above technical problems, the present invention adopts the following technical solutions:

A heat exchanger is provided, including: multiple microstructure sheets, each of the microstructure sheets including a heat exchange region with a microstructure, and an edge region with an inlet region and an outlet region, and the microstructure including multiple hollow protrusions; and multiple gaskets for microstructure sheets, each of the gaskets for microstructure sheets having an inlet port and an outlet port corresponding to the inlet region and outlet region respectively, where the multiple gaskets for microstructure sheets are alternately stacked with the multiple edge regions.

A method for manufacturing a heat exchanger is provided, including: forming microstructure sheets, each of the microstructure sheets including a heat exchange region with a microstructure, and an edge region with an inlet region and an outlet region; and forming gaskets for microstructure sheets, each of the gaskets for microstructure sheets having an inlet port and an outlet port corresponding to the inlet region and outlet region respectively, where the microstructure sheets are alternately stacked and combined with the gaskets for microstructure sheets to form the heat exchanger.

Further, the microstructure sheets and the gaskets for microstructure sheets are formed through a stamping process; and/or, combining each of the gaskets for microstructure sheets with the edge region through an atomic diffusion bonding process to form a working fluid channel sheet.

Beneficial effects of the present invention are as follows: Selectivity of forming processes is expanded by setting the microstructures as the hollow protrusions. For example, the microstructure sheets and the gaskets for microstructure sheets can be formed using a stamping process. Compared with a conventional etching process, the stamping process is simple, low in production cost, high in production efficiency, and low in environmental pollution.

### BRIEF DESCRIPTION OF THE DRAWINGS

FIG. 1 is a schematic three-dimensional view of a compact heat exchanger according to the present invention;

FIG. 2 is a three-dimensional exploded view of a compact heat exchanger according to the present invention;

FIG. 3 is a schematic three-dimensional view of some working fluid channel sheets, where a second working fluid channel sheet is located on an upper side;

FIG. 4 is a top view of FIG. 3;

FIG. 5 is a partially exploded view of FIG. 3;

FIG. 6 is a schematic three-dimensional view of some working fluid channel sheets, where a first working fluid channel sheet is located on an upper side;

FIG. 7 is a top view of FIG. 6;

FIG. 8 is a partially exploded view of FIG. 6;

FIG. 9 is a sectional view of FIG. 4 taken along a direction AA;

FIG. 10 is a cross-sectional view of FIG. 9;

FIG. 11 is a cross-sectional view of a guide portion arranged at an end portion of a working fluid channel sheet in FIG. 9;

FIG. 12 is a cross-sectional view of a second embodiment showing that end surfaces of working fluid channel sheets are misaligned;

FIG. 13 is a cross-sectional view of a third embodiment showing that end surfaces of working fluid channel sheets are misaligned;

FIG. 14 is a cross-sectional view of a fourth embodiment showing that end surfaces of working fluid channel sheets are misaligned;

FIG. 15 is a cross-sectional view of a fifth embodiment showing that end surfaces of working fluid channel sheets are misaligned;

FIG. 16 is a schematic view of alternately stacking multiple microstructure sheets and multiple gaskets for microstructure sheets;

FIG. 17 is a schematic structural view of an auxiliary limiting plate; and

FIG. 18 is a schematic view of a method for manufacturing another heat exchanger according to the present invention.

### DETAILED DESCRIPTION

The present invention will be described in detail below in combination with specific implementations shown in the accompanying drawings. However, these implementations do not limit the present invention, and any changes made by those of ordinary skill in the art to structures, methods, or functions according to these implementations fall within the protection scope of the present invention.

In the various illustrations of the present invention, for the convenience of illustration, certain dimensions of the structures or portions may be exaggerated relative to other structures or portions. Therefore, they are only used to illustrate the basic structure of the subject matter of the present invention.

For the convenience of description, an upper side and a lower side are defined according to orientations according to a method for manufacturing a heat exchanger of the present invention in an actual application process. “Connection” described herein can be a direct connection or an indirect connection through another quick connector/adapter. “Direct connection” refers to no other structure or quick connector between two elements.

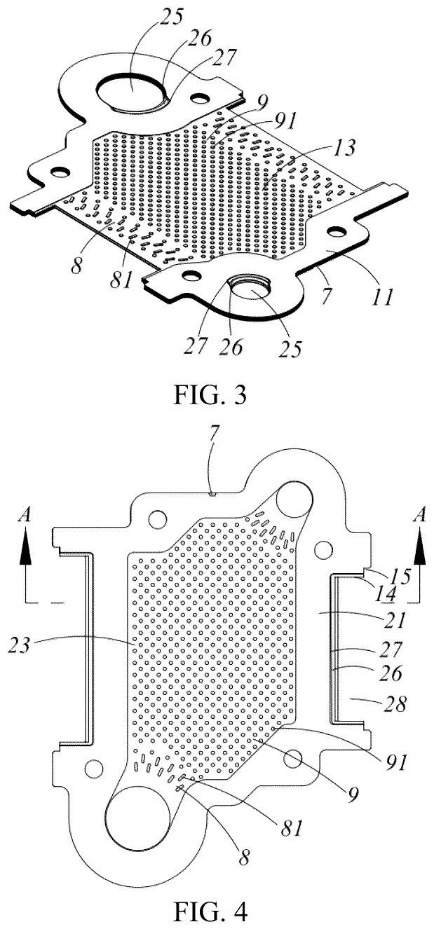

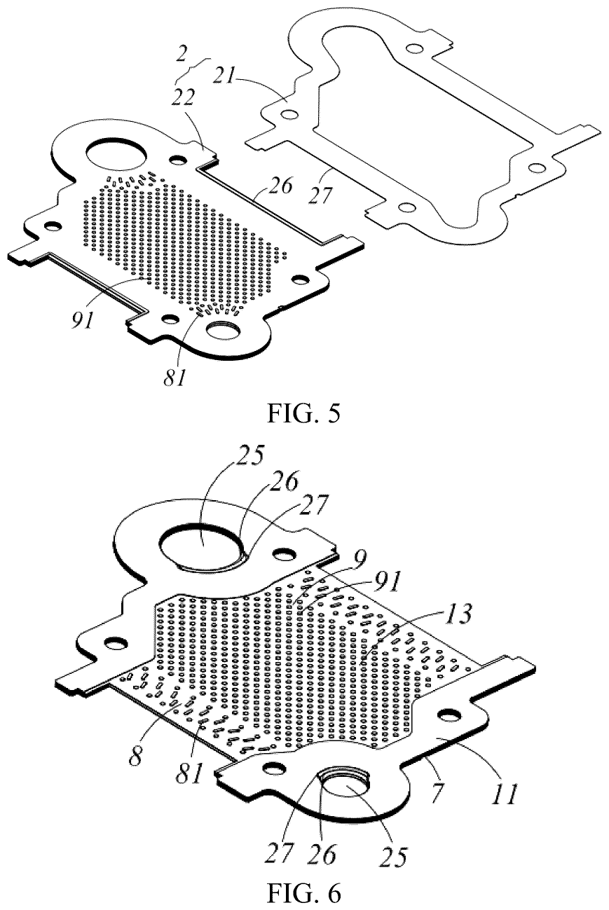

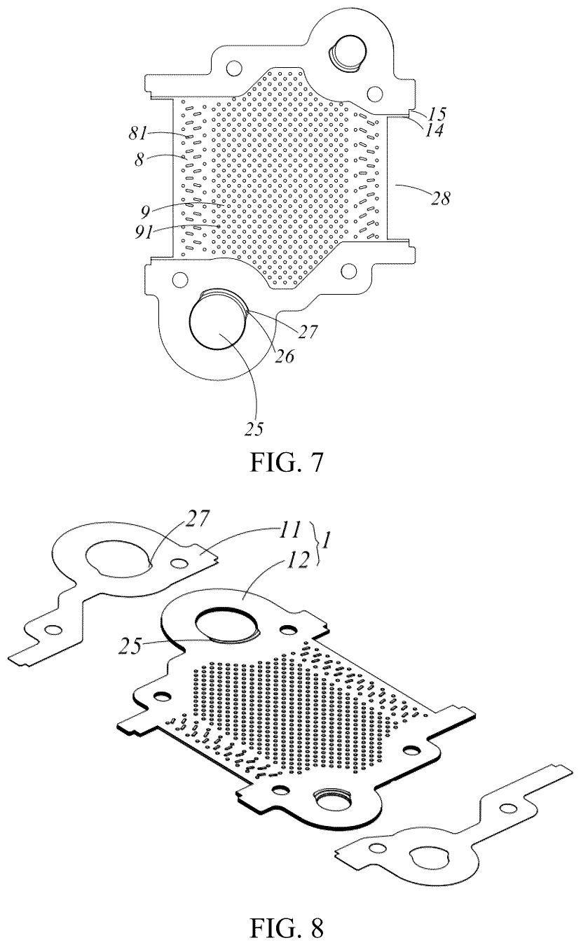

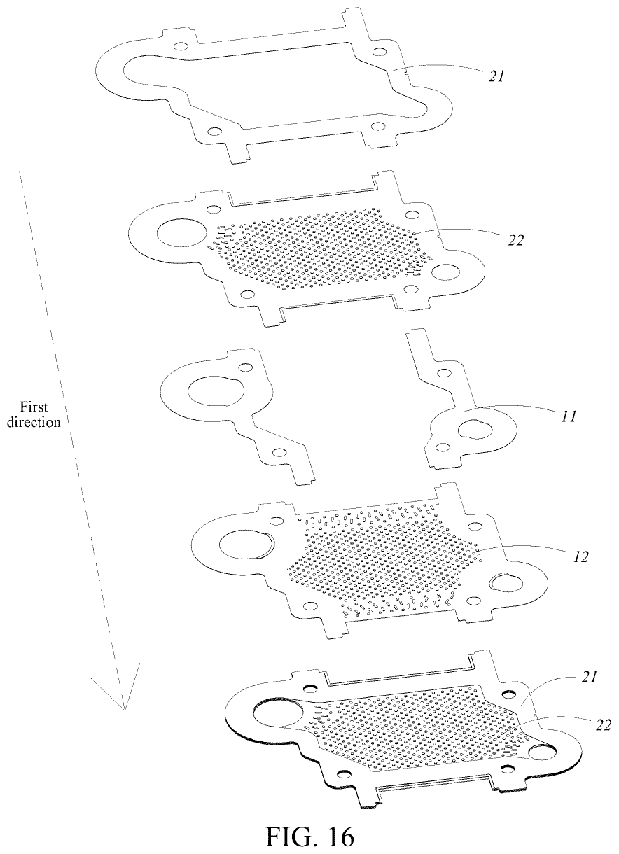

Referring to FIG. 1 to FIG. 18, the present invention designs a compact heat exchanger and a manufacturing method therefor on the basis of a “thermal resistance balance theory”, a stamping process, and an atomic diffusion bonding process, and aims to design a heat exchanger with low manufacturing cost, high production yield, compact structure, and good heat exchange performance.

The heat exchanger includes multiple working fluid channel sheets stacked in a first direction, and working fluid channels formed between two adjacent working fluid channel sheets. One of two adjacent channels is configured to communicate a first fluid, and the other channel is configured to communicate a second fluid. The first fluid and the second fluid transfer heat in a case that there is a temperature difference between the first fluid and the second fluid.

The inventor has found in the study that multiple microstructures arranged on the working fluid channel sheets can classify the working fluid channels into multiple parallel or cross-connected microchannels, which can improve the heat exchange performance of the heat exchanger. In a conventional structure, each of the working fluid channel sheets includes a heat exchange region and an edge region. The microstructure is arranged in the heat exchange region. The edge region needs to protrude towards a side where the microstructure is located, to form a dam in the heat exchange region to prevent a fluid from flowing outwards, and also needs to be combined with the working fluid channel sheet on the other side, that is, a thickness of the heat exchanger needs to be greater than a thickness of the heat exchange region. If a stamping process is used to form the working fluid channel sheet, the manufacturing cost can be reduced. However, after the microstructures and the dam are stamped, a concave cavity corresponding to the microstructures and the dam is formed on the other side of the working fluid channel sheet, and cannot be combined with an adjacent working fluid channel sheet. As a result, the working fluid channel sheet cannot be formed by the stamping process.

After conducting a further study, the inventor has designed each of the working fluid channel sheets as follows: The working fluid channel sheet includes a gasket for microstructure sheet, and a microstructure sheet. The gasket and the microstructure sheet are stacked in a first direction. From the perspective of a direction perpendicular to the working fluid channel sheet, a shape of the microstructure sheet is the same as a shape of the working fluid channel sheet, and the microstructure sheet also has a heat exchange region and an edge region corresponding to the working fluid channel sheet. The gasket for microstructure sheet has a same shape as a shape of the dam, and the gasket for microstructure sheet is located on one side of the microstructure sheet that is provided with the microstructure.

In the present invention, the working fluid channel sheet is divided into two portions in the first direction, and the gasket for microstructure sheet and the microstructure sheet can be respectively formed using the stamping process. Then, the gasket and the microstructure sheet are stacked and combined together through atomic diffusion bonding. Compared with a conventional method for forming the working fluid channel sheet based on an etching process, the present invention is suitable for mass production, and has a significant mass production effect on the production cost, high production efficiency, and low environmental pollution.

The inventor has found in the study that if a thickness of the gasket for microstructure sheet and a thickness of the microstructure sheet are smaller, the finally formed heat exchanger has a lighter weight, lower thermal resistance, and better heat exchange performance. However, based on the boundedness of current sheet materials and their properties, as well as the stamping process, the thickness of the gasket for microstructure sheet and the thickness of the microstructure sheet should not exceed 0.1 mm, such as 0.1 mm, 0.09 mm, 0.08 mm, 0.07 mm, and 0.075 mm.

When the microstructure sheet is formed through the stamping process, the microstructure is formed on the sheet to form the heat exchange region, thereby completing a basic structure of the microstructure sheet. The microstructure is a hollow protrusion. Spaces between multiple protrusions are communicated to form the microchannel, to divide the fluid into multiple small streams for heat exchange, which improves the heat exchange performance.

In the present invention, the study shows that the thickness of the microstructure sheet, a size of each of the protrusions, and the space between the protrusions jointly determines the pressure resistance between the first fluid and the second fluid. Specifically, if the thickness of the microstructure sheet is larger, a diameter of each of the protrusions is larger, the space between the protrusions is smaller, and the pressure resistance between the first fluid and the second fluid is higher. Therefore, a height of each of the protrusions, the diameter of each of the protrusions, and the space between the adjacent protrusions are designed and optimized on the basis of the performance of a sheet material, a limit of the stamping process, the pressure resistance between the adjacent microstructure sheets, a hydraulic diameter of each working fluid channel, and flow loss.

Preferably, a ratio of a width of the microchannel to the thickness of the microstructure sheet is not greater than 3. The width of the microchannel is equal to a width of the space between two adjacent protrusions.

Specifically, the height of each of the protrusions is not less than the thickness of the microstructure sheet. Preferably, the height of each of the protrusions is consistent with a height of the microstructure sheet. The diameter of each of the protrusions is not greater than 0.7 mm, preferably not less than 0.5 mm, which is the optimal design that considers the performance of a stamping die and the performance of the microstructure sheet. An intermediate spacing between two adjacent protrusions is between 0.5 mm and 2.5 mm, preferably between 1 mm and 1.5 mm.

Preferably, two adjacent rows of protrusions are misaligned, which further increases the disturbance to the fluids and improves the heat exchange performance. In one embodiment, a projection of each of the protrusions on an adjacent row of protrusions is located right in the middle between two adjacent protrusions, and the protrusions are uniformly distributed. Support points between two adjacent microstructure sheets are uniform.

The thickness of the gasket for microstructure sheet is consistent with the height of each of the protrusions. During the formation of the heat exchanger by stacking, both the protrusion and the gasket for microstructure sheet are combined with another microstructure sheet. The protrusion divides the working fluid channel into the microchannels, and the gasket for microstructure sheet is combined with the edge region to form the dam.

The width of the gasket for microstructure sheet, and top and bottom plates on two sides of the multiple working fluid channel sheets jointly determine the pressure resistance of the heat exchanger. The present invention selects the width of the gasket for microstructure sheet on the basis of the pressure resistance of the heat exchanger and an atomic diffusion bonding process, for example, between 2.5 mm and 5 mm.

In addition, the microstructure sheet is provided with an inlet region and an outlet region which are communicated to the working fluid channel for fluid to flow into the heat exchange region. The gasket for microstructure sheet has an inlet port and an outlet port corresponding to the inlet region and the outlet region respectively. According to the arrangement of the inlet port and the outlet port, the gasket for microstructure sheet can be one-piece or multi-piece.

Preferably, the inlet region and the outlet region are each provided with a flow guide microstructure, which, on the one hand, guided the fluids, and on the other hand, is combined with an adjacent layer of microstructure sheets to form a support point, to improve their bonding and compressive strength. In a specific embodiment, an arrangement density of the flow guide microstructures is less than an arrangement density of the microstructures in the heat exchange region, so the flow guide microstructures serve as a buffer region for the fluids to enter, with low flow resistance. Moreover, the flow guide microstructures have a larger area than the microstructures and provide a high supporting force for the adjacent microstructure sheets.

The structures of all the microstructure sheets and the structures of all the gaskets for microstructure sheets can be the same. During stacked placement, directions where the inlet regions and the outlet regions of two adjacent microstructure sheets are located are intersected, that is, the first fluid and the second fluid enter a first working fluid channel and a second working fluid channel in the heat exchanger in different directions.

Further, to adapt to two different fluids, the working fluid channel sheets include a first working fluid channel sheet 1 and a second working fluid channel sheet 2 which are alternately arranged. The first working fluid channel sheet 1 and the second working fluid channel sheet 2 are respectively provided with different microstructures, so that the working fluid channels include a first working fluid channel defined by the microstructures of the first working fluid channel sheet 1 and the second working fluid channel sheet 2, and a second working fluid channel defined by the microstructures of the second working fluid channel sheet 2 and the first working fluid channel sheet 1. Specifically, the first working fluid channel sheet 1 includes a gasket 11 for first microstructure sheet and a first microstructure sheet 12 which are stacked in the first direction, and the second working fluid channel sheet 2 includes a gasket 21 for second microstructure sheet and a second microstructure sheet 22 which are stacked in the first direction.

“Alternate arrangement” refers to the following explanation: The first working fluid channel sheet 1 includes a first A surface and a first B surface, and the second working fluid channel sheet 2 includes a second A surface and a second B surface. For example, the first A surface and the first B surface are respectively an upper surface and a lower surface of the first working fluid channel sheet 1, and the second A surface and the second B surface are respectively a lower surface and an upper surface of the second working fluid channel sheet 2. The first working fluid channel sheet 1 and the second working fluid channel sheet 2 are alternately stacked in a face-to-face manner with the first A surface and the second A surface; a first working fluid channel 13 for allowing the first fluid to flow is formed between the first A surface and the second A surface; and a second working fluid channel 23 for allowing the second fluid to flow is formed between the first B surface and the second B surface.

Or, the gaskets for microstructure sheets include a gasket 11 for first microstructure sheet and a gasket 21 for second microstructure sheet. The microstructure sheets include a first microstructure sheet 12 and a second microstructure sheet 22. The gasket 11 for first microstructure sheet is stacked on one side of the first microstructure sheet 12 that is provided with the microstructures to form the first working fluid channel sheet 1, and the gasket 21 for second microstructure sheet is stacked on one side of the second microstructure sheet 22 that is provided with the microstructures to form the second working fluid channel sheet 2. Therefore, the first working fluid channel sheet 1 and the second working fluid channel sheet 2 are alternately stacked in sequence to form the compact heat exchanger.

In the present invention, the first fluid represents a low-pressure fluid, and the second fluid represents a high-pressure fluid. For example, the first fluid is water, and the second fluid is a refrigerant. Of course, in other embodiments, it is not limited to heat exchange between the water and the refrigerant, but two other kinds of fluids can also exchange heat.

As shown in FIG. 6 to FIG. 8, the inlet region and outlet region of the first microstructure sheet 12 are respectively arranged on two opposite sides of the first microstructure sheet. The gasket 11 for first microstructure sheet includes two separate portions which respectively form the dams on two sides of a non-inlet region and non-outlet region of the first microstructure sheet 12. A first fluid inlet for allowing the water to flow in is formed in a water inlet region located between the two portions of the gasket 11 for first microstructure sheet, and a first fluid outlet for allowing the water to flow out is formed in the outlet region. For convenience of description, it is defined that the gasket 11 for first microstructure sheet is arranged on front and rear sides, and the first fluid inlet and the first fluid outlet are located on left and right sides.

The gasket 21 for second microstructure sheet is of an annular structure arranged around the second microstructure sheet 22, and the inlet region and outlet region of the second microstructure sheet 22 are both located on an inner side of the gasket 21 for second microstructure sheet.

In other embodiments, the gasket 21 for second microstructure sheet can also be similar to the gasket 11 for first microstructure sheet, including two portions which are arranged on two opposite sides of the second microstructure sheet 22. The second fluid inlet and second fluid outlet can be arranged in the same or opposite direction as the first fluid inlet and first fluid outlet, to form a homodromous flow or a reverse flow with a first fluid layer. The second fluid inlet and the second fluid outlet can also be arranged on the left and right sides, to a direct crossing flow with the first fluid layer. Alternatively, the gasket 11 for first microstructure sheet can also be similar to the gasket 21 for second microstructure sheet. The second fluid inlet and second fluid outlet can be arranged in the same or opposite direction as the first fluid inlet and first fluid outlet, or an arrangement direction of the second fluid inlet and second fluid outlet can be perpendicular to an arrangement direction of the first fluid inlet and first fluid outlet.

The first working fluid channel sheet 1 and the second working fluid channel sheet 2 are each provided with a first sunken portion 14 and a second sunken portion 15 communicated to the first sunken portion 14 on the sides where the inlet region and outlet region of the first working fluid channel sheet 1, that is, the first sunken portion 14 and the second sunken portion 15 are located on the left side and right side of each of the first working fluid channel sheet 1 and the second working fluid channel sheet 2. The second sunken portion 15 is formed by being further sunken from front and rear opposite inner walls of the first sunken portion 14.

In a specific embodiment, the first sunken portion 14 and the second sunken portion 15 are arranged on both the left side and right side of each of the first microstructure sheet 12, the gasket 21 for second microstructure sheet, and the second microstructure sheet 22. Since the gasket 11 for first microstructure sheet is located on the front side and rear side, the gasket 11 for first microstructure sheet does not have the first sunken portion 14, but it has the second sunken portion 15.

The second sunken portion 15 is located on an outer side. A width of the second sunken portion 15 in a front-rear direction is greater than a width of the first sunken portion 14. A depth of the second sunken portion 15 in a left-right direction is less than a depth of the first sunken portion 14. In addition, the widths of both the first sunken portion 14 and the second sunken portion 15 on one side are greater than the widths of both the first sunken portion 14 and the second sunken portion 15 on the other side.

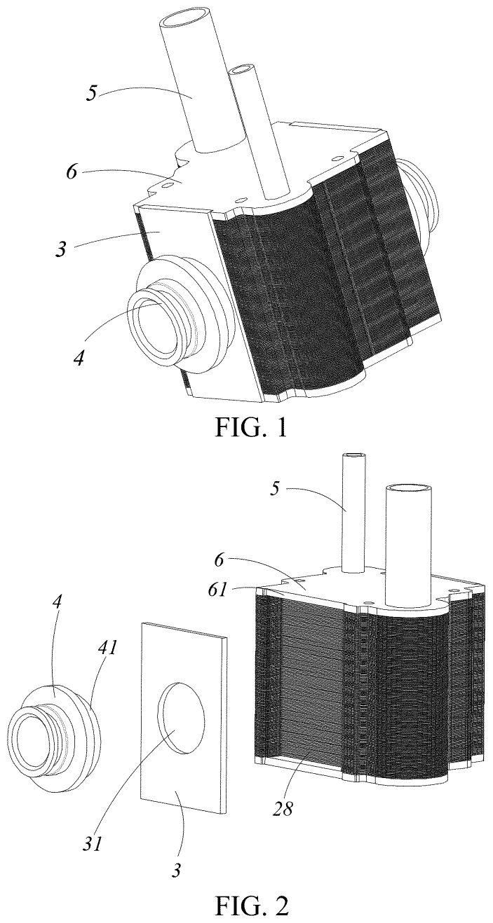

As shown in FIG. 1 and FIG. 2, the compact heat exchanger further includes a connecting plate 3 arranged on the first fluid inlet and first fluid outlet side, and a first fluid pipe 4 connected to the connecting plate 3. The connecting plate 3 has a connecting hole 31 that matches the first fluid pipe 4, and the connecting plate 3 is fixed to the inner wall of the second sunken portion 15 by welding. Of course, the connecting plate 3 can also be fixed to the inner wall of the second sunken portion 15 by an adhesive or a screw. In this embodiment, the first fluid pipe 4 includes a first fluid inlet pipe and a first fluid outlet pipe. The first fluid pipe 4 is a connecting pipe for water flowing, and fluid distribution chambers 28 are formed between the connecting plate 3 and an inlet of the first working fluid channel, and between the connecting plate 3 and an outlet of the first working fluid channel. An end portion of the connecting pipe is located inside the connecting hole 31 and is fixed to an inner wall of the connecting hole 31, and/or, the connecting pipe is arranged in the connecting hole 31 in a penetrating manner, and an end portion of the connecting pipe is fixed to one side of the connecting plate 3 facing the working fluid channel sheet.

In this embodiment, the end portion of the connecting pipe is located inside the connecting hole 31 and is fixed to the inner wall of the connecting hole 31, which means that the connecting pipe will not extend into the fluid distribution chambers 28, thereby ensuring sufficient spaces reserved at a water inlet end and a water outlet end to ensure that the water smoothly enters the first working fluid channel. Similarly, there is a sufficient space reserved at the water outlet end to ensure that the water smoothly flows out of the compact heat exchanger. Furthermore, since the connecting pipe is located in the connecting hole 31, the connecting pipe will not become a resistance to the flowing of the water in the fluid distribution chambers 28. The connecting pipe also has a stop portion 41 that is matched with a wall surface of the working fluid channel sheet facing away from the connecting plate 3 to prevent excessive mounting of the connecting pipe, thereby effectively avoiding that the connecting pipe extends into the fluid distribution chambers 28 during the mounting of the connecting pipe.

The connecting pipe is connected to the inner wall of the connecting hole 31 by welding. On the one hand, a welding position is located inside the compact heat exchanger, ensuring the integrity of the compact heat exchanger and improving the aesthetics. On the other hand, a space for the connecting pipe and the connecting hole 31 on an outer side wall surface of the connecting plate 3 facing away from the working fluid channel sheet. Therefore, there can be a larger space on the outer side of the compact heat exchanger to design and mount more elements. When the elements meet requirements, the overall structure can be further narrowed, achieving a compact design, which is conducive to formation of a miniaturized component by the heat exchanger and other structures. Moreover, since the sinking depth of the second sunken portion 15 is less than the depth of the first sunken portion 14, a thickness of the connecting plate 3 is relatively small, and a mass of the connecting plate 3 is also relatively small, which has little impact on the overall mass of the compact heat exchanger and is conducive to a lightweight design of the heat exchanger.

Of course, in other embodiments, the connecting pipe can also protrude out of an inner side wall surface of the connecting plate 3 facing the working fluid channel sheet, that is, a portion of the connecting pipe protruding out of the wall surface of the connecting plate 3 facing the working fluid channel sheet is located inside the fluid distribution chambers 28. Therefore, the connecting pipe can be also welded to the inner side wall surface of the connecting plate 3 to improve the fixing effect of the connecting plate 3 and the connecting pipe. Moreover, due to the large depth of the first sunken portion 14, which means that the fluid distribution chambers 28 also have large spaces, this can ensure smooth flowing of the water.

In this embodiment, since the first fluid inlet and the first fluid outlet of the first working fluid channel sheet 1 are respectively arranged on the left side and the right side, the water flows in one direction as a whole in the first working fluid channel, without any changes in direction or turning. Therefore, it can ensure stable flowing of the water in the first working fluid channel, thereby ensuring the stability of the overall heat transfer.

In this embodiment, two layers of working fluid channel sheets forming the working fluid channel are each provided with a first end portion 16 and a second end portion 24 encircled to form an inlet of the working fluid channel; and at least a portion of the first end portion 16 and at least a portion of the second end portion 24 are misaligned along an extension direction of the working fluid channel.

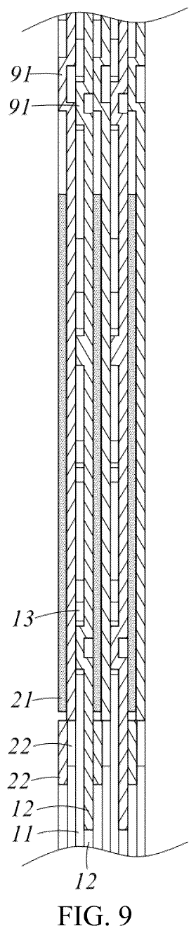

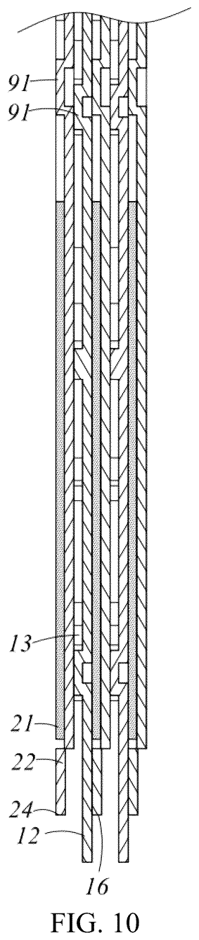

As shown in FIG. 9 and FIG. 10, specifically, the first end portion 16 is an end portion of the first microstructure sheet 12, and the second end portion 24 can be an end portion of the gasket 21 for second microstructure sheet and/or the second microstructure sheet 22. In this embodiment, the first microstructure sheet 12 protrudes out of the gasket 21 for second microstructure sheet and the second microstructure sheet 22 along the first working fluid channel, and there is a gasket 21 for second microstructure sheet and a second microstructure sheet 22 between two adjacent first microstructure sheets 12. Therefore, when the five layers of structures, namely the first microstructure sheet 12, the gasket 21 for second microstructure sheet, the second microstructure sheet 22, the gasket 11 for first microstructure sheet, and the first microstructure sheet 12, are observed as a group, a size of the first working fluid channel inlet is a distance between two adjacent first microstructure sheets 12, and a height of the first working fluid channel is a distance between the second microstructure sheet 22 and the first microstructure sheet 12. Obviously, the former is greater than the latter, which facilitates the water to enter the first working fluid channel, improves the stability of the heat exchanger, and improves heat exchange efficiency.

As shown in FIG. 9 and FIG. 10, in order to ensure that the water can continuously and stably enter the first working fluid channel, the second microstructure sheet 22 protrudes out of the gasket 21 for second microstructure sheet along the extension direction of the first working fluid channel, and the second microstructure sheet 22 has a positioning portion 26 that protrudes in a direction away from the first microstructure sheet 12. The positioning portion 26 is integrally formed by stamping the second microstructure sheet 22. Therefore, after stacking, there is a step between the first microstructure sheet 12 and the second microstructure sheet 22, and the first working fluid channel gradually decreases inwards from the inlet, ensuring the smooth flowing of the water.

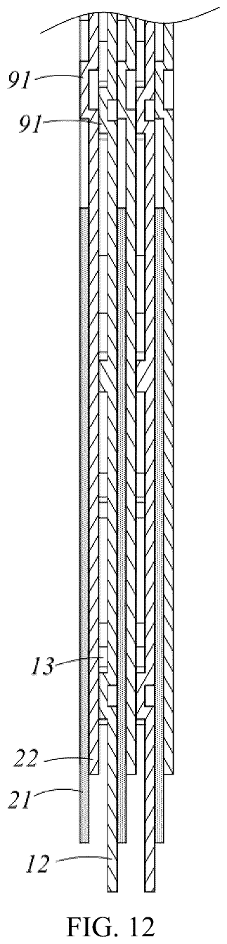

As shown in FIG. 12, the present invention further provides a second embodiment of misaligned end surfaces of working fluid channel sheets. Specifically, the gasket 21 for second microstructure sheet can also protrude out of the second microstructure sheet 22 along the first working fluid channel, and the second microstructure sheet 22 does not need to be provided with a positioning portion 26, which can also form the step structure as described above.

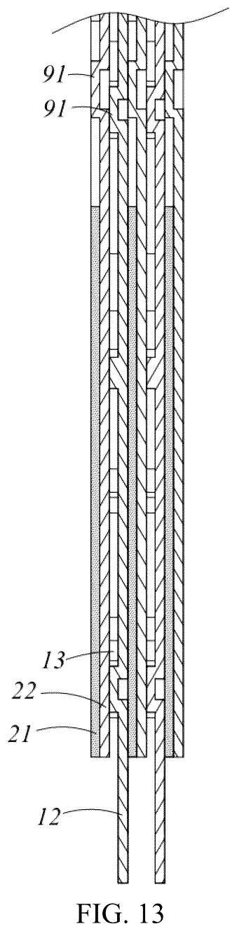

As shown in FIG. 13, the present invention further provides a third embodiment of misaligned end surfaces of working fluid channel sheets. An end portion of the gasket 21 for second microstructure sheet and an end portion of the second microstructure sheet 22 can also be flush in an up-down direction. Alternatively, the second microstructure sheet 22 protrudes out of the gasket 21 for second microstructure sheet along the first working fluid channel, but does not have the positioning portion 26.

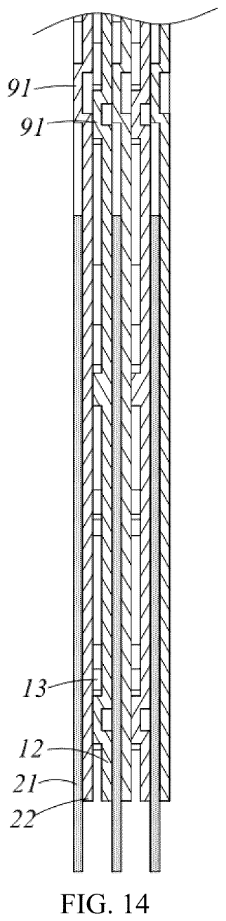

As shown in FIG. 14, in addition to the aforementioned embodiments, the present invention further provides a fourth embodiment of misaligned end surfaces of working fluid channel sheets. Specifically, the gasket 21 for second microstructure sheet can also protrude out of the first microstructure sheet 12 along the first working fluid channel, where there are two situations: the gasket 21 for second microstructure sheet protrudes out of the second microstructure sheet 22 and the second microstructure sheet 22 protrudes out of the gasket 21 for second microstructure sheet. When the five layers of structures, namely the gasket 21 for second microstructure sheet, the second microstructure sheet 22, the gasket 11 for first microstructure sheet, the first microstructure sheet 12, and the gasket 21 for second microstructure sheet, are observed as a group, in a first case, a second microstructure sheet 22, a gasket 11 for first microstructure sheet, and a first microstructure sheet 12 exists between two adjacent gaskets 21 for second microstructure sheets. Therefore, after stacking, the inlet of the first working fluid channel is trumpet-shaped, which can ensure the smooth flowing of the water.

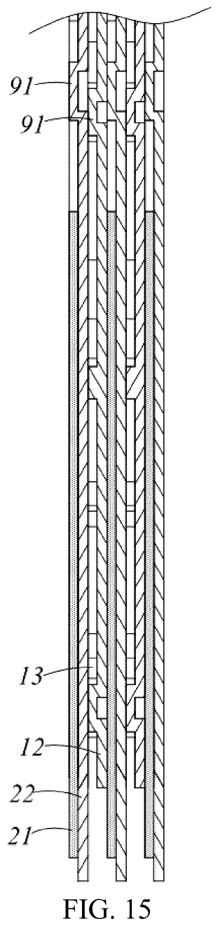

As shown in FIG. 15, in a second case, the present invention further provides a fifth embodiment of misaligned end surfaces of working fluid channel sheets. When the second microstructure sheet 22, the gasket 11 for first microstructure sheet, the first microstructure sheet 12, and the gasket 21 for second microstructure sheet are observed as a group, after stacking, it is similar to the above structure that the first microstructure sheet 12 protrudes out of the gasket 21 for second microstructure sheet and the second microstructure sheet 22 along the first working fluid channel.

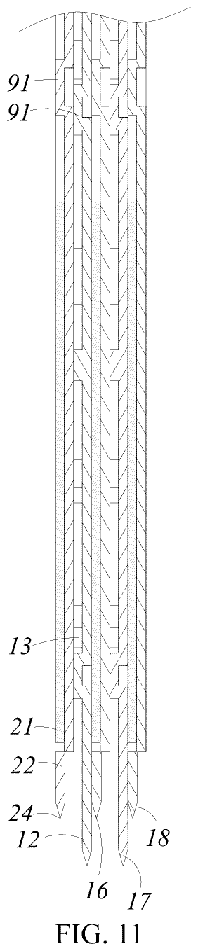

As shown in FIG. 11, in order to further reduce a flowing resistance, the first end portion 16 and the second end portion 24 also have guide portions 17. Each guide portion 17 has a guide slope 18 on an upper side and/or a lower side, and the guide slope 18 is a plane or a cambered surface. That is, the first microstructure sheet 12, the gasket for refrigerant microstructure sheet, and the second microstructure sheet 22 also have guide portions 17 arranged at their end portions. When the guide slopes 18 are cambered surfaces, the guide slopes include concave surfaces and convex surfaces. Therefore, combining the misaligned stacked sheets and the guide portions 17 can greatly reduce the flowing resistance. Of course, either the misaligned stacked sheets or the guide portions 17 can be arranged according to an actual situation.

In this embodiment, a misalignment distance between every two of the first microstructure sheet 12, the gasket 21 for second microstructure sheet, and the second microstructure sheet 22 is within a range of 0.2-0.7 mm, and is preferably 0.5 mm. Therefore, the misalignment distance is small, which can ensure a small volume of the compact heat exchanger, and can also reduce the flowing resistance, making it easier for the water to enter a first fluid layer flow channel.

In this embodiment, the first microstructure sheet 12, the second microstructure sheet 22, the gasket 11 for first microstructure sheet, and the gasket 21 for second microstructure sheet also have through holes 25 that penetrate through in the up-down direction. The through holes 25 of the first microstructure sheet 12, the second microstructure sheet 22, the gasket 11 for first microstructure sheet, and the gasket 21 for second microstructure sheet are arranged on the front and rear sides and are diagonally arranged. It can also be understood that if the first fluid inlet and the first fluid outlet are arranged on the left and right sides, the through holes 25 are arranged on the front and rear sides. The through hole 25 on the front side is arranged on the left, and the through hole 25 on the rear side is arranged on the right, or the through hole 25 on the front side is arranged on the right, and the through hole 25 on the rear side is arranged on the left. Each gasket 11 for first microstructure sheet is only provided with one through hole 25. After the first working fluid channel sheet 1 and the second working fluid channel sheet 2 are stacked, the through holes 25 form a channel for a refrigerant to enter and leave. Of course, when if the first fluid inlet and the first fluid outlet are arranged on the front and rear sides, the through holes 25 are arranged on the left and right sides.

Upper and lower sides of the compact heat exchanger are respectively connected to a second fluid pipe 5. The second fluid pipe 5 includes a second fluid inlet pipe and a second fluid outlet pipe. In this embodiment, the second fluid pipe 5 is a refrigerant pipe. Therefore, an inlet of the refrigerant pipe and an inlet of a refrigerant channel are arranged in a cross manner. That is, the refrigerant in the compact heat exchanger first enters the refrigerant channel in the up-down direction, then flows horizontally along the refrigerant channel, and finally flows out of the compact heat exchanger in the up-down direction. In this embodiment, the second fluid pipe 5 is perpendicular to the second working fluid channel 23. Therefore, when the refrigerant enters the second working fluid channel sheet, the refrigerant is bent once, which increases the disturbance of the refrigerant, allowing gas and liquid to be fully mixed, avoiding the refrigerant from being separated into gas and liquid in the second fluid layer channel, ensuring a uniform refrigerant temperature, and improving the heat exchange stability.

Moreover, since the connecting pipe is arranged on the two opposite sides in a horizontal direction, and the refrigerant pipe is arranged on the upper and lower sides, a space around the compact heat exchanger is fully utilized, which avoids a large local pipeline density and achieves ease of design, mounting, and maintenance of pipelines. Moreover, positions of the first fluid inlet and the first fluid outlet are opposite to positions of the second fluid inlet and the second fluid outlet. For example, in this embodiment, assuming that the first fluid inlet is located on the left side and the first fluid outlet is located on the right side, the second fluid inlet is arranged on the right side and the second fluid outlet is arranged on the left side. Therefore, a flowing direction of the water is from left to right, and an overall flowing direction of the refrigerant is from right to left. Therefore, the water and the refrigerant form a counter flow design, which maximizes the heat exchange efficiency. Of course, in other embodiments, the first fluid inlet and the first fluid outlet are located on the front and rear sides, and the inlet and outlet for the refrigerant are located on the rear and front sides. Alternatively, the first fluid inlet and the second fluid inlet, as well as the first fluid outlet and the second fluid outlet, are arranged on the same sides.

In this embodiment, outer diameters of the two through holes 25 arranged diagonally are not the same. When the compact heat exchanger is used as a condenser, the larger through hole 25 serves as the second fluid inlet; and when the compact heat exchanger is used as an evaporator, the smaller through hole 25 serves as the second fluid inlet. The condenser is taken as an example: For the condenser, a gaseous high-pressure and high-temperature refrigerant passes through the inlet, and the liquid high-pressure refrigerant passes through the outlet. Densities of the gaseous refrigerant and the liquid refrigerant are greatly different. To ensure a certain refrigerant flowrate and control the refrigerant flowrate within a certain range, it is necessary to select a thicker pipe as a high-pressure gas pipe and select a thinner liquid pipe which is an outlet pipe of the condenser.

Among the through holes 25 on the same side, an inner diameter of the through hole 25 of the first microstructure sheet 12 is the same as an inner diameter of the through hole 25 of the second microstructure sheet 22.

In this embodiment, the thicknesses of the gasket 11 for first microstructure sheet, the first microstructure sheet 12, the gasket 21 for second microstructure sheet, and the second microstructure sheet 22 are consistent and not greater than 0.1 mm. Therefore, the heights of the first working fluid channel and the second working fluid channel are also not greater than 0.1 mm and are preferably 0.1 mm. This not only ensures stable stamping manufacturing, but also can significantly improve the heat exchange performance. If a space between the first microstructure sheet 12 and the second microstructure sheet 22 is smaller, the water and the refrigerant will be less shunted, and the heat exchange performance is better.

The gasket 11 for first microstructure sheet and the gasket 21 for second microstructure sheet can play a role in improving the structural strength, and more importantly, the gasket 11 for first microstructure sheet and the gasket 21 for second microstructure sheet form the dams of the first working fluid channel sheet 1 and the second working fluid channel sheet 2, thereby preventing the water and the refrigerant from leaking and ensuring normal flowing of the water and the refrigerant.

In order to ensure that the gasket 11 for first microstructure sheet, the first microstructure sheet 12, the gasket 21 for second microstructure sheet, and the second microstructure sheet 22 can be efficiently and orderly stacked together, all of them are provided with via holes. The compact heat exchanger further includes base plates 6 located at upper and lower ends, and a positioning column arranged on the lower base plate 6. In this embodiment, the via holes are arranged at four corners. During assembling, the above four elements are inserted onto the lower base plate 6 in sequence. After the stacking is completed, the upper base plate 6 is inserted onto the positioning column, and finally the atomic diffusion bonding is performed to complete the manufacturing of the compact heat exchanger. The base plate 6 has a sealing portion 61 that is matched with a wall surface of one side of the connecting plate 3 close to the working fluid channel sheet to achieve sealing between the connecting plate 3 and the working fluid channel sheet, thereby reducing the risk of leakage of the fluids between the connecting plate 3 and the base plate 6.

However, for the convenience of insertion, an outer diameter of the positioning column needs to be less than an inner diameter of each via hole, so the above four elements are prone to misalignment. In order to ensure accurate alignment between the gasket 11 for first microstructure sheet and the first microstructure sheet 12, as well as between the gasket 21 for second microstructure sheet and the second microstructure sheet 22, the first microstructure sheet 12 and the second microstructure sheet 22 are each further provided with the protruding positioning portion 26 described above. The gasket 11 for first microstructure sheet and the gasket 21 for second microstructure sheet each have a limiting portion 27 that matches the positioning portion 26.

By the arrangement of the positioning portion 26 and the limiting portion 27, the accurate alignment is ensured. Meanwhile, the accurate alignment avoids the gaskets for microstructure sheets from being skewed outwards, which fully ensures welding areas of the gaskets for microstructure sheets and the microstructure sheets during the atomic diffusion bonding, improves the welding effect, also avoids the gaskets for microstructure sheets from being skewed inwards, avoids a decrease in the widths of the first working fluid channel and the refrigerant channel, and guarantees the heat exchange performance.

In this embodiment, the positioning portion 26 on the first microstructure sheet 12 is arranged around the through hole 25, and is formed by being stamped and protruding around an inner wall of the through hole 25. The limiting portion 27 of the gasket 11 for first microstructure sheet is a recess that continues to be sunken outwards from the through hole 25. The recess is communicated to the through hole 25. Therefore, inner diameters of the through hole 25 of the gasket 11 for first microstructure sheet and the recess are slightly greater than the inner diameter of the through hole 25 of the first microstructure sheet 12 overall, thereby achieving positioning by sleeving the recess of the gasket 11 for first microstructure sheet on an outer side of the positioning portion 26.

Since the through hole 25 is round, the positioning portion 26 of the first microstructure sheet 12 is formed by being stamped around the inner wall of the through hole 25. Therefore, the through hole 25 and the positioning portion 26 are not round as a whole, and the through hole 25 and the recess are also not round as a whole. When the gasket 11 for first microstructure sheet is mounted on the first microstructure sheet 12, a stop structure is formed at a connection between the recess and the through hole 25, thereby preventing the gasket 11 for first microstructure sheet from rotating and achieving accurate positioning of the gasket 11 for first microstructure sheet and the first microstructure sheet 12.

By use of the through holes 25 to arrange the positioning portion 26 and the limiting portion 27, on the one hand, by full use of the structures of the through holes 25, the mold design changes little, making it easy for stamping forming, and the manufacturing is simple. On the other hand, the heat exchange region of the first microstructure sheet 12 is enlarged as much as possible, thereby improving the heat exchange performance.

The positioning portion 26 on the second microstructure sheet 22 is formed by protruding from its two opposite sides and is integrally formed by stamping. In this embodiment, the positioning portion 26 is located at an edge of the second microstructure sheet 22 and is formed by being stamped and protruding around an inner wall of the first sunken portion 14. The limiting portion 27 of the gasket 21 for second microstructure sheet is its two opposite sides, that is, the gasket 21 for second microstructure sheet is clamped between the positioning portions 26 on both sides, which can ensure the accurate positioning of the gasket 21 for second microstructure sheet. Furthermore, sizes of the two sides of the gasket 21 for second microstructure sheet are designed to be relatively small, without conducting a structural design. This greatly reduces the production cost. Of course, in other embodiments, the above two kinds of positioning portions 26 can also be interchanged structurally, and positioning can be achieved through cooperation between grooves and convex points.

The compact heat exchanger further includes order identification structures 7 that ensure orderly stacking of the gasket 11 for first microstructure sheet, the first microstructure sheet 12, the gasket 21 for second microstructure sheet, and the second microstructure sheet 22. In this embodiment, the order identification structures 7 are gaps arranged on the second microstructure sheet 22 and the gasket 21 for second microstructure sheet. The gaps are formed by being sunken from two sides of both the second microstructure sheet 22 and the gasket 21 for second microstructure sheet, but the first microstructure sheet 12 and the gasket 11 for first microstructure sheet are not provided with the gaps. Therefore, a feature that the refrigerant working fluid channel sheet has the gaps and the first working fluid channel sheet 1 does not have the gaps is achieved during the stacking, so that it is convenient to identify whether there is a stacking error.

Along the working fluid channel from the first fluid inlet to the first fluid outlet, the first microstructure sheet 12 has a transition region 8 (corresponding to the inlet region or outlet region) and a heat exchange region 9 for the water to flow. In this embodiment, the first microstructure sheet 12 has two transition regions 8 arranged on left and right sides of the heat exchange region 9, respectively. The first microstructure sheet 12 has multiple first protrusions 81 that form the transition regions 8 and multiple second protrusions 91 that form the heat exchange region 9. An arrangement density of the first protrusions 81 is less than an arrangement density of the second protrusions 91, so that it is convenient for the water to flow into and out of the transition regions 8. The heat exchange region 9 can fully disturb the water, which not only enlarges a heat exchange region, but also prolongs the heat exchange time, thereby improving the heat exchange performance. In this embodiment, in order to further improve the heat exchange performance, the transition regions 8 are also provided with multiple the second protrusions 91.

Similarly, along a direction from the second fluid inlet to the second fluid outlet, the second microstructure sheet 22 also has transition regions 8 and a heat exchange region 9 for the refrigerant to flow. However, in the second microstructure sheet 22, the second fluid inlet and the second fluid outlet are diagonally arranged, so that the transition regions 8 are also diagonally arranged. Similarly, the second microstructure sheet 22 also has multiple first protrusions 81 that form the transition regions 8 and multiple second protrusions 91 that form the heat exchange region 9.

In this embodiment, the first protrusions 81 and the second protrusions 91 are both unidirectional protrusions formed by stamping. Protrusion heights of the first protrusions 81 and protrusion heights of the second protrusions 91 are not greater than 0.1 mm, preferably 0.1 mm, that is, the protrusion heights of the first protrusions 81 and the protrusion heights of the second protrusions 91 are consistent with the thickness of the gasket 11 for first microstructure sheet, the thickness of the first microstructure sheet 12, the thickness of the gasket 21 for second microstructure sheet, and the thickness of the second microstructure sheet 22. That is, the height of the working fluid channel is equal to the protrusion height. Furthermore, the gaskets for microstructure sheets and the protrusions have the same heights, which facilitates stable connection and fixing between two adjacent layers during the atomic diffusion bonding.

Further, the first protrusions 81 and the second protrusions 91 of both the first microstructure sheet 12 and the second microstructure sheet 22 are arranged in the same direction. It should be noted that the first protrusions 81 and the second protrusions 91 are formed by stamping, so that compared with conventional protrusions formed by etching, which are of solid structures, the first protrusions 81 and the second protrusions 91 have hollow structures inside. Therefore, the compact heat exchanger of the present application requires a small number of production materials, has lower costs and a lighter weight, is convenient to mount and remove, and can be applied to more scenarios.

In this embodiment, each first protrusion 81 is in a cross-sectional shape of a convex lens or is capsule-shaped. The first protrusion 81 has drainage portions located on two sides. The drainage portions are arranged towards the inlet and outlet of the first working fluid channel, thereby reducing the flowing resistance, making it easier for the water to flow into or out of the heat exchange region 9, and ensuring smooth flowing in and out of the water. Of course, the first protrusion 81 can also be in a shape of water drops, elliptical, or in another shape. The second protrusion 91 is round.

Therefore, the second protrusion 91 can also effectively reduce the flowing resistance. The multiple first protrusions 81 and the multiple second protrusions 91 are arranged in multiple columns in the left-right direction, and two adjacent columns of first protrusions 81 are arranged in a misaligned manner. Similarly, two adjacent columns of second protrusions 91 are also arranged in a misaligned manner. Therefore, the first protrusions 81 and second protrusions 91 of the latter column can further disperse the water or refrigerant flowing through the former column, thereby strengthening the disturbance of the water and the refrigerant in the flow channel, enlarging the heat exchange area, and improving the heat exchange performance.

Moreover, the first protrusions 81 of the first microstructure sheet 12 are radially arranged, namely, forming a trumpet shape. The first protrusions 81 on the left are taken as an example. The first protrusions 81 in the rear half gradually tilt backwards from left to right, and the first protrusions 81 in the front half gradually tilt forwards from left to right. Therefore, the protrusions are arranged in the trumpet shape as a whole. When the water enters, the water can be guided to the front and back ends, avoiding concentration at a middle position, which fully utilizes the space in the first working fluid channel. The heat exchange is more uniform, thereby improving the heat exchange performance. Similarly, the first protrusions 81 of the second microstructure sheet 22 are also arranged radially.

In this embodiment, the first protrusions 81 and the second protrusions 91 are both unidirectional protrusions and protrude in the same direction. Meanwhile, the second protrusions 91 of the first microstructure sheet 12 and the second protrusions 91 of the second microstructure sheet 22 are eccentrically arranged, that is, a circle center of the second protrusions 91 of the first microstructure sheet 12 and a circle center of the second protrusions 91 of the second microstructure sheet 22 are at different positions in the up-down direction, but these second protrusions have intersected common portions in the up-down direction. Therefore, part of the second protrusions 91 of the second microstructure sheet 22 on the lower side abut against a bottom surface of the first microstructure sheet 12 on the upper side, and the other part of the second protrusions face cavities of the second protrusions 91 of the first microstructure sheet 12, so that during the atomic diffusion bonding, the second protrusions 91 between the adjacent first microstructure sheet 12 and second microstructure sheet 22 jointly achieve supporting, which greatly reduces the risk of compression deformation between the first microstructure sheet 12 and the second microstructure sheet 22.

In this embodiment, in each row of the second protrusions 91 in the left-right direction in the heat exchange region 9, a distance between two adjacent second protrusions 91 is 0.5 mm to 1.5 mm, preferably 1 mm. In each column of the second protrusions 91 in the front-rear direction, a distance between two adjacent second protrusions 91 is also 0.5 mm to 1.5 mm, preferably 1 mm. Furthermore, a diameter of each second protrusion 91 is not greater than 0.5 mm and is preferably 0.5 mm. In addition, a misalignment distance between two adjacent rows of second protrusions 91 or two adjacent columns of second protrusions 91 is 1 mm.

Therefore, by the reasonable arrangement of the second protrusions 91 mentioned above, it can be ensured that there are enough second protrusions 91. This can effectively reduce the risk of damaging the microstructure sheets during stamping, and can ensure that the water or refrigerant is fully disturbed in the flow channel to improve the heat exchange efficiency. Meanwhile, more second protrusions 91 can be arranged inside the limited heat exchange region 9, which is also convenient for stamping forming, thereby enlarging the heat exchange area and improving the heat exchange performance.

The following will provide a detailed description of a method for manufacturing a compact heat exchanger.

A method for manufacturing a heat exchanger includes the following steps: forming microstructure sheets, each of the microstructure sheets including a heat exchange region with a microstructure, and an edge region with an inlet region and an outlet region; and forming gaskets for microstructure sheets, each of the gaskets for microstructure sheets having an inlet port and an outlet port corresponding to the inlet region and outlet region respectively, where the gaskets for microstructure sheets are alternately stacked and combined with the edge regions to form the heat exchanger.

In this method, the microstructure sheets and the gaskets for microstructure sheets are formed separately as two portions, so that selectivity of forming processes is expanded. For example, the microstructure sheets and the gaskets for microstructure sheets can be formed using a stamping process. Compared with a conventional etching process, the stamping process is suitable for batch production, and has a significance mass production effect on the production cost, high production efficiency, and low environmental pollution.

Specifically, the heat exchanger and the gaskets for microstructure sheets are formed through the stamping process, and the stamping process specifically uses first-level stamping.

The gaskets for microstructure sheets and the microstructure sheets are alternately stacked, and then are combined into a whole through atomic diffusion bonding.

After the protrusions are formed through the stamping process, concave cavities corresponding to the protrusions are formed on the other sides of the microstructure sheets, that is, the protrusions of hollow structures. During the alternate stacking of the gaskets for microstructure sheets and microstructure sheets, the protrusions on two adjacent microstructure sheets are eccentrically arranged, that is, a central axis of the protrusions on one microstructure sheet does not overlap a central axis of the protrusions on the adjacent microstructure sheet. That is, the protrusions on one microstructure sheet at least partially correspond to a portion of the adjacent microstructure sheet that is not provided with the protrusions, thereby achieving the atomic diffusion bonding.

Preferably, an eccentric distance of the protrusions on two adjacent microstructure sheets is between ⅓ and ⅔ of a diameter of each of the protrusions, preferably greater than ½ of the diameter, to ensure effective bonding between the two adjacent microstructure sheets.

During the stacking of the microstructure sheets and the gaskets for microstructure sheets, orderly stacking is achieved through the order identification structures described above, and all the sheets are aligned in the first direction through the positioning portions, the via holes, and the positioning columns described above. The atomic diffusion bonding is then performed.

The atomic diffusion bonding process includes the following steps: cleaning; stacking; pressing using a fixture; performing atomic diffusion bonding using a vacuum furnace at a vacuum pressure of 4×10⁻³ Pa; and applying a pressure of 5 MPa at about 1100° C.

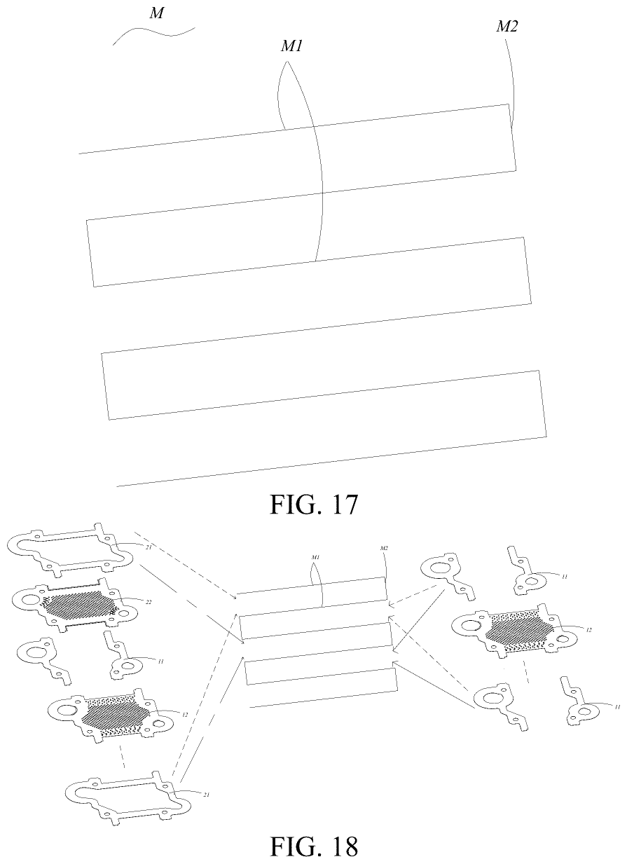

In a method for manufacturing another heat exchanger, as shown in FIG. 17 and FIG. 18, an auxiliary limiting plate M is formed by bending a sheet material. The auxiliary limiting plate M includes multiple limiting sheets M1 arranged in parallel, and connecting sheets M2 connecting adjacent limiting sheets M1. Preferably, the limiting sheets M1 and the connecting sheets M2 are arranged in a serpentine manner.

A distance between two adjacent limiting sheets M1 is set to be able to accommodate a certain number of microstructure sheets and gaskets for microstructure sheets. During stacking, multiple microstructure sheets and multiple gaskets for microstructure sheets are alternately inserted between adjacent limiting sheets M1. The multiple microstructure sheets and the multiple gaskets for microstructure sheets are limited in a fixed space through the limiting sheets M1 to prevent deformation or skewing of the microstructure sheets and the gaskets for microstructure sheet due to their thermal expansion during the atomic diffusion bonding.

Preferably, each limiting sheet M1 has the same structure as each of the microstructure sheets and can be used as a microstructure sheet of the heat exchanger. Moreover, when the microstructure sheets include a first microstructure sheet and a second microstructure sheet with different microstructures, the limiting sheet M1 can be either the first microstructure sheet or the second microstructure sheet. A manufacturing process is as follows: The microstructures are first formed by stamping on the sheet material, and the sheet material is then bent to form the auxiliary limiting plate M.

Preferably, a thickness of each limiting sheet M1 is consistent with the thickness of each gasket for microstructure sheet, and a distance between two adjacent limiting sheets M1 is a singular multiple of the thickness of each limiting sheet M1. In one embodiment, each limiting sheet M1 is provided with the microstructures or is not provided with the microstructures, but since it is used as a microstructure sheet, n gaskets for microstructure sheets and n−1 microstructure sheet are alternately inserted according to a manner of a gasket for microstructure sheet, a microstructure sheet, a gasket for microstructure sheet, a microstructure sheet, . . . , a gasket for microstructure sheet. In another embodiment, the limiting sheet M1 only plays a limiting role, and m microstructure sheets and m−1 gasket for microstructure sheet are alternately inserted according to a manner of a microstructure sheet, a gasket for microstructure sheet, a microstructure sheet, a gasket for microstructure sheet, . . . , and a microstructure sheet.

In addition, a quantity of the limiting sheets M1 does not exceed 6, and the number of times of bending is within a bearing range of the sheet material. In a specific embodiment, 6 limiting sheets M1 are provided, and 5 connecting sheets M2 are provided. The entire heat exchanger is divided into 5 units for combination.

A formation process of the microstructure sheets and the gaskets for microstructure sheets, an arrangement method of the microstructure sheets and the gaskets for microstructure sheets between two adjacent limiting sheets M1, and the atomic diffusion bonding process all refer to the above descriptions and will not be repeated here.

A method for manufacturing another heat exchanger includes: forming an auxiliary limiting plate M, where the auxiliary limiting plate M is the same as the auxiliary limiting plate in the above embodiment, including multiple limiting sheets M1 arranged in parallel, and connecting sheets M2 connecting adjacent limiting sheets M1; alternately stacking multiple first working fluid channel sheets and multiple second working fluid channel sheets between two adjacent limiting sheets M1; and combining the auxiliary limiting plate M, the first working fluid channel sheets, and the second working fluid channel sheets to form the heat exchanger.

The first working fluid channel sheets and the second working fluid channel sheets have different microstructures.

Further, the limiting sheets M1 have the same structures as the first working fluid channel sheets, or the limiting sheets M1 have the same structures as the second working fluid channel sheets.

Of course, the above method is also applicable to the working fluid channel sheets formed by combining the above-mentioned microstructure sheets and the above-mentioned gaskets for microstructure sheets.

It should be understood that although this specification is described according to the implementations, not each implementation only includes one independent technical solution. This narration method of this specification is only for clarity. A person skilled in the art should regard this specification as a whole, and the technical solutions in the respective implementations can also be appropriately combined to form other implementations that can be understood by a person skilled in the art.

A series of detailed explanations listed above are only specific explanations for feasible implementations of the present invention, and are not intended to limit the protection scope of the present invention. Any equivalent implementations or changes made without departing from the spirit of the present invention shall all fall within the protection scope of the present invention.

1. A heat exchanger, comprising:
a plurality of microstructure sheets, each of the microstructure sheets comprising a heat exchange region with a microstructure, and an edge region with an inlet region and an outlet region, and the microstructure comprising a plurality of hollow protrusions; and
a plurality of gaskets for microstructure sheets, each of the gaskets for microstructure sheets having an inlet port and an outlet port corresponding to the inlet region and outlet region respectively, wherein
the plurality of microstructure sheets are alternately stacked with the plurality of gaskets for microstructure sheets.

2. The heat exchanger according to claim 1, wherein each of the microstructure sheets comprises a microchannel located between adjacent protrusions, and a ratio of a width of the microchannel to a thickness of each of the microstructure sheets is not greater than 3.

3. The heat exchanger according to claim 1, wherein a height of each of the protrusions is not greater than a thickness of each of the microstructure sheets, and/or a diameter of each of the protrusions is not greater than 0.7 mm.

4. The heat exchanger according to claim 1, wherein a center distance between two adjacent protrusions is between 0.5 mm and 2.5 mm.

5. The heat exchanger according to claim 1, wherein two adjacent rows of protrusions on each of the microstructure sheets are misaligned.

6. The heat exchanger according to claim 1, wherein the protrusions on two adjacent microstructure sheets are eccentrically arranged.

7. The heat exchanger according to claim 6, wherein an eccentric distance of the protrusions on two adjacent microstructure sheets is between ⅓ and ⅔ of a diameter of each of the protrusions.

8. The heat exchanger according to claim 1, wherein a thickness of each of the gaskets for microstructure sheets is consistent with a height of the microstructure.

9. The heat exchanger according to claim 1, wherein a width of each of the gaskets for microstructure sheets is between 2.5 mm and 5 mm.

10. The heat exchanger according to claim 1, wherein each of the microstructure sheets and each of the gaskets for microstructure sheets form a working fluid channel sheet; the heat exchanger comprises a plurality of working fluid channel sheets stacked in a first direction, and working fluid channels formed between two adjacent working fluid channel sheets; two adjacent working fluid channel sheets forming the working fluid channel are each provided with a first end portion and a second end portion encircled to form an inlet of the working fluid channel; and at least a portion of the first end portion and at least a portion of the second end portion are misaligned along an extension direction of the working fluid channel.

11. A method for manufacturing a heat exchanger, comprising:
forming microstructure sheets, each of the microstructure sheets comprising a heat exchange region with a microstructure, and an edge region with an inlet region and an outlet region; and
forming gaskets for microstructure sheets, each of the gaskets for microstructure sheets having an inlet port and an outlet port corresponding to the inlet region and outlet region respectively, wherein
the microstructure sheets are alternately stacked and combined with the gaskets for microstructure sheets to form the heat exchanger.

12. The method for manufacturing a heat exchanger according to claim 11, wherein
the microstructure sheets and the gaskets for microstructure sheets are formed through a stamping process; and/or
combining each of the gaskets for microstructure sheets with the edge region through an atomic diffusion bonding process to form a working fluid channel sheet.

13. The method for manufacturing a heat exchanger according to claim 12, wherein the microstructure comprises a plurality of hollow protrusions formed by stamping; a height of each of the protrusions is not greater than a thickness of each of the microstructure sheets; or a diameter of each of the protrusions is not greater than 0.7 mm; or a center distance between two adjacent protrusions is between 0.5 mm and 2.5 mm.

14. The method for manufacturing a heat exchanger according to claim 13, wherein when the gaskets for microstructure sheets are alternately stacked with the edge regions, the protrusions on two adjacent microstructure sheets are eccentrically arranged; and an eccentric distance between the protrusions on two adjacent microstructure sheets is between ⅓-⅔ of the diameter of each of the protrusions.

15. The method for manufacturing a heat exchanger according to claim 12, wherein the atomic diffusion bonding process comprises the following steps: cleaning; stacking; pressing using a fixture; performing atomic diffusion bonding using a vacuum furnace at a vacuum pressure of 4×10⁻³ Pa; and applying a pressure of 5 MPa at about 1100° C.
